(19) United States
(12) Patent Application Publication
(10) Pub. No.: US 2019/0250538 A1
(43) Pub. Date: Aug. 15, 2019

(54) SILICONE RUBBER COMPOSITION, FIXING MEMBER, FIXING ROLLER, AND MANUFACTURING METHOD OF FIXING MEMBER

(71) Applicant: Konica Minolta, Inc., Tokyo (JP)

(72) Inventors: Yoshiyasu MATSUMOTO, Tokyo (JP); Hiroyuki Yasukawa, Tokyo (JP); Hirofumi Koga, Tokyo (JP)

(21) Appl. No.: 16/249,607

(22) Filed: Jan. 16, 2019

(30) Foreign Application Priority Data
Feb. 9, 2018 (JP) 2018-021600

(51) Int. Cl. G03G 15/20; C08G 77/04

(52) U.S. Cl. CPC G03G 15/206; G03G 2215/2051; C08G 77/04

(57) ABSTRACT

There is provided a silicone rubber composition forming a rubber member on a surface of a fixing member which is used in an electrophotographic image forming apparatus. The silicone rubber composition includes 1.5 or less of a low molecular weight component by a cumulative amount measured from 10 minutes to 32 minutes after starting retention in a head space gas chromatography measurement under a predetermined condition. The silicone rubber composition further includes 2.2 or more of a high molecular weight component by a cumulative amount from 32 minutes to 37 minutes after starting retention in a head space gas chromatography measurement under the predetermined condition.

### BACKGROUND

### Technological Field

The present invention relates to silicone rubber composition, fixing member, fixing roller, and manufacturing method of fixing member. More specifically, the present invention relates to a fixing member with silicone rubber member used in an electrophotographic image forming apparatus including a silicone rubber compound which has excellent durability and can suppress pollution of peripheral members due to volatilization of low molecular components in the silicone rubber. The present invention also relates to a fixing member and a fixing roller provided with a rubber member formed from the silicone rubber composition. The present invention also relates to a method of manufacturing the fixing member.

### Description of the Related Art

In an electrophotographic image forming apparatus (hereinafter also referred to as “image forming apparatus”), a fixing roller, a fixing belt, or the like is used as a fixing member for fixing a toner image Silicone rubber is often used as these fixing members.

In recent years, it has been pointed out that a low molecular weight compound such as low molecular weight siloxane volatilize from silicone rubber of the fixing roller and are discharged from the image forming apparatus. It is reported that such low molecular weight compound contaminates the environment inside the image forming apparatus, adheres to electronic parts and the like, and causes contact failure. It has also been reported that the volatilized low molecular weight compound forms particles and contaminates the inside of the image forming apparatus.

As a known example of a fixing member, there is known a pressure roller (a fixing member) in which a silicone rubber layer is formed on a core metal (core material) and an outer surface of the silicone rubber layer is coated with a fluororesin layer (See Japanese Unexamined Patent Application Publication No. 2012-185247). The end portions of the pressure roller is exposed to the outside without being covered with the fluororesin layer, and is made of a silicone rubber having a lower volatile component content and a higher hardness than the other portions.

In the above-described fixing roller described in Japanese Unexamined Patent Application Publication No 2012-185247, the area of the silicone rubber layer exposed to the outside is reduced in order to prevent volatile components of a low molecular weight compound such as low molecular weight siloxane from diffusing to the outside from the silicone rubber layer. Further, the portion exposed to the outside is composed of a silicone rubber having a specific volatile component in a low content. As a result, the content of volatile components of the silicone rubber in the exposed portion at the end face portion can be suppressed to 10 μg/mL or less.

However, according to the method of this known example, it is necessary to coat the outer surface of the silicone rubber layer with a fluororesin layer. Therefore, there is a problem that labor and cost are required. Further, as low molecular weight compounds such as low molecular weight siloxane are continuously discharged from the silicone rubber layer, there is also a problem that, when used for a long time, the interior of the image forming apparatus is contaminated.

Further, in order to reduce contamination in the apparatus, various methods for reducing volatile components of silicone rubber have been conventionally proposed. For example, heating processing, reduced pressure drying processing by reducing pressure, washing processing with various solvents, and the like are known. However, although internal contamination is improved by such processing, it is known that elasticity and durability of rubber decrease.

There is a need for a silicone rubber composition which suppresses contamination of peripheral members due to volatilization of low molecular weight components in the silicone rubber and which is excellent in durability.

### SUMMARY

The present invention has been made in view of the above problems and circumstances. The objects of the present invention are to provide a silicone rubber composition capable of forming a silicone rubber which suppresses contamination of peripheral members due to volatilization of low molecular components in silicone rubber and which is excellent in durability, a fixing member and a fixing roller including a rubber member formed with the silicone rubber composition, and method for manufacturing the fixing member.

To achieve at least one of the abovementioned objects, according to an aspect of the present invention, there is provided a silicone robber composition forming a rubber member on a surface of a fixing member which is used in an electrophotographic image forming apparatus including: 1.5 or less of a low molecular weight component by a cumulative amount measured from 10 minutes to 32 minutes after starting retention m a bead space gas chromatography measurement under a predetermined condition; and 2.1 or more of a high molecular weight component by a cumulative amount measured from 32 minutes to 37 minutes after starting retention in a head space gas chromatography measurement under the predetermined condition.

According to a second aspect of the present invention, there is provided a fixing member which is used in an electrophotographic image forming apparatus, including a rubber member on a surface of the fixing member, wherein the rubber member is formed from the silicone rubber composition according to the first aspect.

According to a third aspect of the present invention, there is provided a fixing roller including the fixing member according to the second aspect, wherein the fixing member includes the rubber member as an outer layer which coats a core material, and wherein a rubber hardness of the rubber member on a shaft is within a range of 30° to 60°.

According to a fourth aspect of the present invention, there is provided a manufacturing method of a fixing member for manufacturing the fixing member according to the second aspect, including a step of introducing gas into a heating device from outside in heating, by the heating device, a fixing member which has a surface having a silicone rubber member and which is placed in the heating device, wherein a maximum temperature in the heating by the heating device is 190° C. or less.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 shows a graph obtained by measuring an example of a silicone rubber composition by head space gas chromatography.

FIG. 2 is a cross-sectional view showing a schematic configuration of an example of a fixing roller.

FIG. 3 is a detailed view showing an example of main parts of a fixing member manufacturing apparatus.

FIG. 4 is an overall perspective view showing a fixing member manufacturing apparatus.

FIG. 5 is an overall side view of the fixing member manufacturing apparatus.

FIG. 6 is a schematic diagram showing a schematic configuration of an electrophotographic image forming apparatus.

### DETAILED DESCRIPTION OF EMBODIMENTS

Hereinafter, one or more embodiments of the present invention will be described with reference to the drawings. However, the scope of the invention is not limited to the disclosed embodiments.

According to the present invention, there is provided a silicone rubber composition forming a rubber member on a surface of a fixing member which is used in an electrophotographic image forming apparatus, including: 1.5 or less of a low molecular weight component by a cumulative amount measured from 10 minutes to 32 minutes after starting retention in a head space gas chromatography measurement under a predetermined condition; and 2.2 or more of a high molecular weight component by a cumulative amount measured from 32 minutes to 37 minutes after starting retention in a head space gas chromatography measurement under the predetermined condition. This is a technical feature common to or corresponding to the following embodiments.

According to the present invention, it is possible to provide a silicone rubber composition, a fixing member, a fixing toller, and a method for manufacturing the fixing member which suppress contamination of peripheral members due to volatilization of low molecular components in the silicone rubber and which are excellent in durability.

The mechanism of expressing effect or working mechanism of the present invention is presumed as follows.

As a result of intensive studies to solve the problem of the present invention, the present inventors found that, with a silicone rubber composition including 1.5 or less of a low molecular weight component by a cumulative amount measured from 10 minutes to 32 minutes after starting retention in a head space gas chromatography measurement under a predetermined condition: and 2.2 or more of a high molecular weight component by a cumulative amount measured from 32 minutes to 37 minutes alter starting retention in a head space gas chromatography measurement under the predetermined condition, it is possible to provide a silicone rubber composition which suppresses contamination of peripheral members due to volatilization of low molecular components in the silicone rubber and which is excellent in durability.

By adjusting the cumulative amount of the low molecular weight component in the silicone rubber composition from 10 minutes to 32 minutes after starting the retention to be 1.5 or less, it is presumed that there are few components that can be contamination in the apparatus.

Further, by adjusting the cumulative amount of the high molecular weight component in the silicone rubber composition from 10 minutes to 32 minutes after starting the retention to be 2.2 or more, it is presumed that a silicone rubber composition excellent in durability could be obtained.

Conventionally, low molecular weight components in the silicone rubber composition has been removed. However, in the conventional methods such as heating processing, reduced pressure drying processing by reducing pressure, or washing processing with various solvents, not only low molecular weight components in the silicone rubber composition, but also high molecular components in the silicone rubber composition are also removed.

According to the present invention, the components in the silicone rubber composition are adjusted so as to reduce a low molecular component(s) and increase a high polymer component(s). The reason why a silicone rubber excellent in durability can be obtained when the silicone rubber composition contains a large amount of the high molecular component is not clear, however, it is presumed that molecular chains in the silicone rubber are not easily broken due to the high molecular component, so that the silicone rubber is hardly deteriorated.

As an embodiment of the present invention, the cumulative amount of the low molecular component of the silicone rubber composition is preferably 1.3 or less and the cumulative amount of the polymer component of the silicone rubber composition is preferably 2.28 or more.

The fixing member of the present invention is used in an electrophotographic image forming apparatus and includes a rubber member on its surface. The fixing member is formed of the silicone rubber composition according to the present invention. The fixing member is a fixing roller including the rubber member as an outer layer coating a core material, and a rubber hardness of the rubber member on a shaft (just above the rotation shaft of the fixing roller) is preferably within a range of 30° to 60°.

A method of manufacturing a fixing member according to the present invention includes a step of introducing gas into a heating device from outside in heating a fixing member having a silicone rubber member on its surface and placed in the heating device, and a maximum temperature in the heating by the heating device is 190° C. or less. Preferably, the maximum temperature in the heating by the heating device is 180° C. or less.

Hereinafter, the present invention, its constituents, and embodiments for carrying out the present invention will be described in detail. In the present application, “to” between numerical values is used to mean that the numerical values before and after the sign are inclusive as the lower limit and the upper limit.

### [Silicone Rubber Composition]

The silicone rubber composition of the present invention is a silicone rubber composition forming a rubber member on a surface of a fixing member used in an electrophotographic image forming apparatus, including 1.5 or less of a low molecular weight component by a cumulative amount measured from 10 minutes to 32 minutes after starting retention in a head space gas chromatography measurement under a predetermined condition; and 2.2 or more of a high molecular weight component by a cumulative amount measured from 32 minutes to 37 minutes after starting retention in a head space gas chromatography measurement under die predetermined condition.

Further, from the viewpoint of more effectively obtaining the effect of the present invention, it is preferable that the cumulative amount of the low molecular weight component is 1.3 or less and the cumulative amount of the high molecular weight component is 2.28 or more, in a head space gas chromatography measurement under a predetermined condition.

The measurement “in a head space gas chromatography under a predetermined condition” according to the present invention means performing head space gas chromatography measurement using the measurement device under column conditions and temperature rising conditions as follows.

Measurement device: (GC-2010 (manufactured by Shimadzu Corp.))

Column conditions DB-5 MS (manufactured by Agilent Technologies, Inc.), column flow rate 3 mL/min, carrier gas (He) 83 kPa

Temperature rising conditions: The time of injecting the sample is set to 0 minutes from the start of retention. After the injection, the oven temperature is kept at 40° C. for 5 minutes, raised to 140° C. at a rising rate of 5° C./min, raised to 320° C. at a rising rate of 20° C./min, and finally kept at 320° C. for 7 minutes. The silicone rubber composition to be measured is dissolved in 1 g of hexane and used as the above sample.

The cumulative amount according to the present invention is defined as “a measured cumulative value (peak area) during a predetermined retention time (e.g., from 10 minutes to 32 minutes or from 32 minutes to 37 minutes after starting retention) in the bead space gas chromatography measurement under the above predetermined condition which has been converted to a value relative to 1 g of hexane.” That is, the cumulative amount of 2.0 means that the measured value (peak area) corresponds to 2.0 g of hexane.

The low molecular weight component according to the present invention is defined as the component(s) measured from 10 minutes to 32 minutes alter starting retention in a head space gas chromatography measurement under the above predetermined condition.

The high molecular weight component according to the present invention is defined as the component(s) measured from 32 minutes to 37 minutes after starting retention in a bead space gas chromatography measurement under the above predetermined condition.

By heating the silicone rubber composition at a predetermined temperature for a predetermined time, it is possible to adjust the cumulative amount of the few molecular weight component and the cumulative amount of the high molecular weight component. The maximum temperature in the heating is preferably 190° C. or less, and more preferably 180° C. or less. The heating time is preferably in the range of 30 to 300 minutes, and more preferably in the range of 35 to 60 minutes.

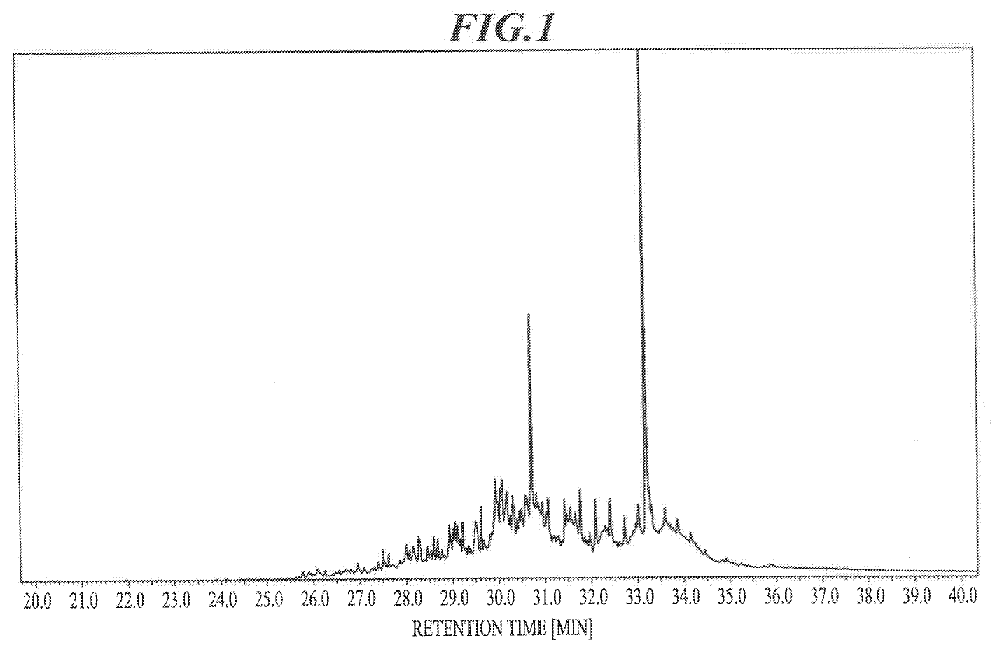

FIG. 1 shows a graph obtained by measuring an example of the silicone rubber composition of the present invention by the predetermined head space gas chromatography (horizontal axis: Time after starting retention (min), vertical axis: arbitrary unit (a value relative to the maximum value of detected intensity of hexane)). FIG. 1 shows detected intensities from 19.6 minutes to 40.4 minutes after starting retention. The peak of the detected intensity of hexane exists between 0 and 19.6 minutes after starting retention time (not shown). The silicone rubber composition whose measurement result is shown in FIG. 1 mainly contains cyclic siloxane 11-mer (D11) to cyclic siloxane 18-mer (D18).

In the example of the silicone rubber composition shown in FIG. 1, the low molecular component is 1.34 by the cumulative amount measured from 10 minutes to 32 minutes after starting retention in the head space gas chromatography measurement under the predetermined conditions, and the low molecular component is 2.51 by the cumulative amount measured from 32 mount to 37 minutes after starting retention.

### [Fixing Member]

The fixing member according to the present invention is used in an electrophotographic image forming apparatus and includes a rubber member on its surface. The rubber member is formed of the silicone rubber composition according to present invention. The (bring member is, for example, a fixing roller or a fixing belt.

### [Fixing Roller]

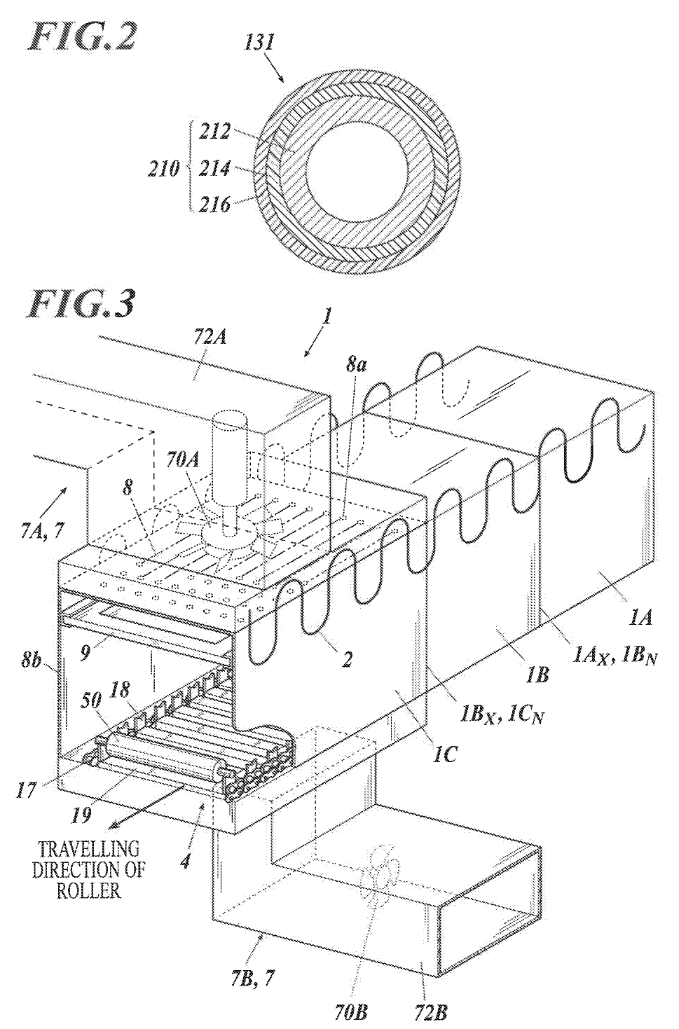

The fixing roller according to the present invention is a rubber roller for fixing toner on a sheet of paper in the electrophotographic image forming apparatus, and includes a core material coated by an outer layer which is a rubber member formed of the silicone robber composition of the present invention. The fixing roller of the present invention is, for example, a cylindrical roller having silicone rubber (hereinafter may be simply referred to as a rubber member) as a surface layer as shown in FIG 2.

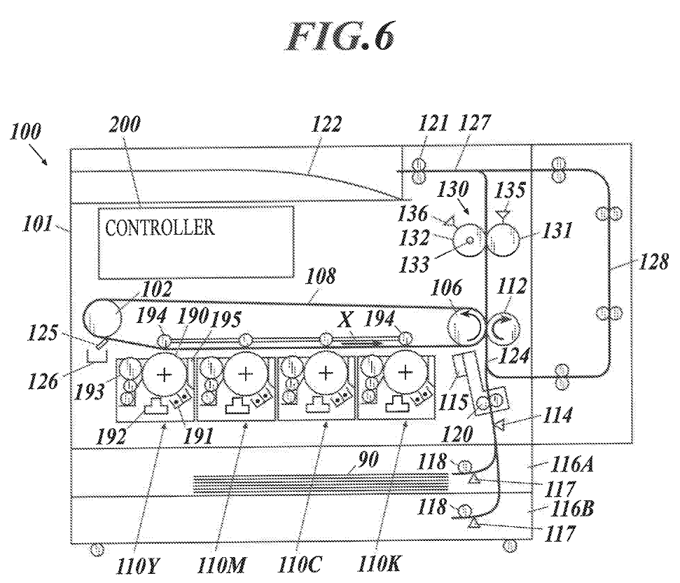

The fixing roller is, for example, a rubber roller including a cylindrical core metal coated by a silicone rubber as an outer layer. Specific examples of the fixing roller are, for example, a heating roller 132 and a pressure roller 131 shown in FIG. 6.

Preferably, the rubber hardness of the rubber member of the fixing roller according to the present invention is within a range of 30° to 60° on its shaft. The rubber hardness can be adjusted by changing, for example, heating temperature and heating time in molding or vulcanization.

The rubber hardness on the shaft is the surface hardness of the fixing roller measured in accordance with J1S-S-6050. Specifically, it is measured with an ASKER-C type rubber hardness tester (manufactured by Kobunshi Keiki Co., Ltd.) under a load of 600 g. In order to measure the rubber hardness on the shaft, the measurement is performed using a positioning member by which the rotation shaft of the roller can be arranged just below the pressing indenter. A roller having an outer diameter of 30 mm including a core material with a diameter of 22 mm and a rubber having a thickness of 4 mm is prepared as a fixing roller and the rubber hardness is measured. In the measurement of the rubber hardness, the hardness is measured in a state where rubber is placed on the surface of the core material.

The fixing roller may include three layers as shown in FIG. 2, including a core metal 212, a solid rubber layer 214 provided so as to cover the outer surface of the core metal 212, and sponge rubber layer 216 provided so as to cover the outer surface of the solid rubber layer 214, but it is not limited thereto. Here, the solid rubber layer 214 and the sponge rubber layer 216 are each made of silicone rubber.

Preferably, the core metal 212 of the fixing roller is made of a metal material such as aluminum, iron, SUS, or the like.

The thickness of the core metal 212 is about 0.1 to 5 mm. From the viewpoint of saving weight and warm-up time, it is more preferably about 0.1 to 1.5 mm.

The diameter of the core metal 212 is preferably about 10 to 50 mm.

The solid rubber layer 214 and the sponge rubber layer 216 are made of silicone rubber as described above.

The silicone rubber has heat resistance against the fixing temperature and elasticity for securing the size (length of a nip portion) of the area for pressing the sheet 90.

The solid rubber layer 214 is a hard layer in i solid state. The thickness of the solid rubber layer 214 is preferably in the range of 5 to 10 mm and more preferably in the range of 7 to 8 mm.

The sponge rubber layer 216 is a sponge-like soft layer containing numerous microballoons. The thickness of the sponge rubber layer 216 is preferably in the range of 5 to 100 μm and more preferably in the range of 80 to 90 μm.

In the present specification, a “silicone rubber precursor” refers to a silicone rubber raw material before curing including a low molecular weight monomer and the like, regarding the silicone rubber forming the rubber member of the fixing member of the present invention.

### [Method of Manufacturing Fixing Member]

The method of manufacturing a fixing member for manufacturing the fixing member according to the present invention includes a step of introducing gas into a heating device from outside in heating a fixing member having a silicone rubber member on its surface and placed in the heating device, and a maximum temperature in the heating by the heating device is 190° C. or less. From the viewpoint of effectively obtaining the effect of the present invention, it is preferable that the maximum temperature in the heating device is 180° C. or less.

The gas to be introduced into die heating device is, for example, ordinary air such as the atmosphere, or gas such as dry nitrogen. However, the kind of the gas introduced into the heating device is not limited as long as the gas in the heating device can be exchanged and as long as the effect of the present invention is not hindered.

In the method of manufacturing a fixing member according to the present invention, the above-described step of introducing gas into a heating device from outside in heating, by the heating device may be performed in heating for molding or vulcanizing a rubber member constituting the fixing member, or may be separately performed in another heating after molding or vulcanization as a separate heating step.

In the embodiment explained below, the “step of introducing gas into a heating device from outside in heating, by the heating device” is performed in heating for molding or vulcanizing a rubber member constituting the fixing member.

Although the details of the heating method in the heating device will be described later, it is not particularly limited. Generally, the silicone rubber precursor stored in the chamber is heated by heating the chamber from the outside. The heating method may be either a batch type or a continuous type. For example, in the case of a batch type, the silicone rubber precursor may be left standing in the chamber and taken out after being heated for a predetermined time. In the case of a continuous type, heating for a predetermined time is performed using a tubular heating chamber in which the silicone rubber precursor moves in the heating.

As shown in FIG. 3 explained later, the heating method is preferably a continuous type. It is preferable that, after heating the silicone rubber precursor to crosslink the rubber raw material, the gas is introduced from the outside and discharged to the outside. As a result, it is possible to prevent the temperature inside the chamber from being lowered by introducing gas, which is preferable from the viewpoint of thermal efficiency. For example, it is possible to efficiently impart thermal energy for crosslinking the rubber raw material.

In the method of manufacturing a fixing member of the present invention, any known method can be used without particular limitation, other than the step of heating the silicone rubber precursor for forming the rubber member of the fixing member.

Specific examples of the fixing roller shown in FIG. 2, which is an example of a rising member, will be described below regarding the steps before the heating step of the present invention, that is, before the steps of forming the silicone rubber precursor to be the rubber member of the fixing member.

First, a curing agent (for example, CAT-1602, manufactured by Shin-Etsu Chemical Co., Ltd.) is added to a rubber raw material including a low molecular weight monomer and the like. After thoroughly mixing with a stirrer, the first mixture is obtained.

Next, to the first mixture arc added thermally expandable microcapsules (for example, Expancel 461which are microballoons manufactured by Akzo Nobel Co.) having been expanded, for example. After mixing with a stirrer, the second mixture including a thermally expandable microcapsules is obtained.

Next, for example, a core metal made of aluminum is covered with a paper tube having a diameter larger than that of the core metal so that the core metal is the center. The first mixture (without the thermally expandable microcapsules) is poured between the paper tube and the core metal and heated for curing. After completion of the curing, the paper tube is removed. Thereby a solid rubber layer is formed.

Subsequently, the second mixture (including the thermally expandable microcapsules) is applied to this solid rubber layer to prepare a silicone rubber precursor.

Next, through the heating step according to the present invention, this silicone rubber precursor becomes a silicone rubber constituting the rubber member of the fixing member.

The method of forming the silicone rubber precursor is not limited to the above. For example, a coating solution containing a rubber raw material may be directly applied onto the core metal to prepare the silicone rubber precursor.

### [Heating Step for Molding or Vulcanization]

In the heating step according to the present invention, the low molecular weight compound remaining in the silicone rubber precursor is reduced by introducing gas into the heating device from outside in beating by the heating device while the silicone rubber precursor is heated.

The step of heating in molding or vulcanization is not particularly limited. Specific examples thereof includes the following two embodiments.

First, in one specific example of the heating step, after heating the silicone rubber precursor in the heating chamber, the gas is introduced from the outside to the heating chamber and discharged to the outside.

In an other specific example of the heating step, the heating step includes moving the heated silicone rubber precursor from the heating chamber to a gas introduction chamber after heating the silicone rubber precursor in the heating chamber, and gas is introduced from the outside to the gas introduction chamber and discharged to the outside.

By providing a gas introduction chamber for introducing gas from the outside and discharging the gas to the outside separately from the heating chamber, it is assumed that a higher effect can be exhibited.

In order to volatilize the low molecular weight compound contained in the silicone rubber as in the above two embodiments, it is preferred that the entire silicone rubber precursor is uniformly heated to be crosslinked at first, and then gas is introduced from and discharged to the outside. In this case, curing (vulcanization) of the silicone rubber is performed by heating, followed by discharging the low molecular weight compound contained in the atmosphere out of the system by exchanging gas. As a result, more low molecular weight compounds can be removed.

When gas is introduced from and discharged to the outside, the silicone rubber precursor is preferably under heating, so that the amount of low molecular weight compound remaining in the silicone rubber is further reduced.

After the silicone rubber precursor is uniformly heated and crosslinked, the silicone rubber precursor may be further heated for a certain period of time for aging processing. In the heating step according to the present invention, gas may be introduced from and discharged to the outside after the aging. The low molecular weight siloxane remaining in the silicone rubber can be further volatilized by such aging processing. As a result, it is possible to further reduce the amount of the low molecular weight compound remaining in the silicone rubber, and to reduce the amount of the low molecular weight compound volatilized during use as a product.

Introduction and discharge of gas are performed in order to remove the low molecular weight compound which have been heated and volatilized. Therefore, from the viewpoint of thermal efficiency, it is preferable to introduce and discharge the gas after hearing the silicone rubber precursor. It is preferable that the gas is introduced from and discharged to the outside at a speed within the range of 0.3×V to 100 V (m³/min), when the total volume of the fixing member is defined as V (m³).

If the gas is introduced from and discharged to the outside at a speed of 0.3×V (m³/min) or more, the volatilized low molecular weight compound does not retain in the chamber As a result, the low molecular weight compound does not re-adhere to the fixing member, and the amount of the low molecular weight compound contained in the fixing member can be reduced effectively

If the gas is introduced from and discharged to the outside at a speed of 100×V (m³/min) or less, the silicone rubber precursor can be heated effectively, that is, a manufacturing method with high thermal efficiency can be obtained. The flow rate of the introduced gas (air etc.) can be measured with a general flowmeter. For example, it can be measured with FLT-H (manufactured by Nippon How Cell Co, Ltd ) or die like.

Here, the total volume V (m³) of the fixing member refers to the total of the volumes of all members constituting the fixing member, which are present in the chamber into which the gas is introduced from the outside and from which the gas is discharged to the outside.

Preferably, the gas unreduced from the outside is inert gas and contains siloxane at 5 mass % or less. According to such a manufacturing method of the fixing member, it is possible to reduce the amount of the low molecular weight compound remaining in the silicone rubber more efficiently and further reduce the amount of the low molecular weight compound volatilized when used as a product.

The gas introduced from the outside is not particularly limited as described above, and various kinds of gas can be used. In particular, compressed air having a moisture content of 5 mass % or less (hereinafter also referred to as “compressed dry air”) or dry nitrogen is preferable for the following reasons. In particular, considering the cost, compressed dry air is preferred. The supplying method of gas is not particularly limited, and a known method may be used. For example, it is possible to supply compressed air trade with a device including a mechanism for removing moisture, or dry nitrogen from a nitrogen cylinder.

The moisture content in the gas introduced from the outside is preferably low, since hydrolysis of silicone rubber due to contact with the moisture can also be suppressed. That is, the gas to be introduced is preferably dried as much as possible, and particularly preferably includes moisture at the content of 5 mass % or less. Further, the gas introduced from the outside preferably contains the low molecular weight compound as much as possible and is an inexpensive gas in order to lower the production cost.

The moisture content in the gas can be measured on the basis of a dew point measured with a dew point meter of XPDM type (manufactured by Mitsubishi Chemical Analytech Co., Ltd.), for example.

From the viewpoint of equalizing the temperature distribution in the chamber, the gas introduced from the outside preferably is blown into the chamber at an angle of 45° or more with respect to the longitudinal direction of the silicone rubber precursor, and more preferably at an angle of 70° or more. Thereby, it is possible to effectively remove the low molecular weight compound volatilized from the silicone rubber precursor. As a result, the amount of the low molecular weight compound remaining in the silicone rubber is further reduced, and the amount of the low molecular weight compound volatilized when used as a product can be further reduced. It is considered to be because, by blowing the gas al the above angle, the low molecular weight compound retaining in the vicinity of the surface of the silicone rubber precursor is removed and the gas in the vicinity of the surface is promoted to be replaced with a gas containing no low molecular weight compound.

It is important that the gas in the chamber is flowing even when volatilizing the low molecular weight compound present inside the silicone rubber precursor preferably in a direction perpendicular to the longitudinal direction of the silicone rubber precursor. When the airflow inside the chamber is a laminar (low, the gas can be suitably kept uniform, and the amount of the low molecular weight compound due to the introduction and discharge of the gas can be reduced more effectively.

### [Fixing Member Manufacturing Apparatus]

Hereinafter, the method of manufacturing the fixing member of the present invention using the fixing member manufacturing apparatus will be specifically described.

FIG. 3 is a detailed view showing an example of a main part of a fixing member manufacturing apparatus 1 (hereinafter also simply referred to as a “manufacturing apparatus”) according to the present invention. FIG. 4 is an overall perspective view showing an example of the fixing member manufacturing apparatus according to the present invention.

The fixing member manufacturing apparatus 1 includes a heating chamber 1A for heating the silicone rubber precursor and a gas introduction chamber 1C to which a roller 50 having the silicone rubber precursor on the surface of a core metal (core material) (hereinafter also simply referred to as a “roller 50”) is conveyed from the heating chamber 1A.

The fixing member manufacturing apparatus 1 further includes an introduction/discharge means 7 for introducing gas from outside of the fixing member manufacturing apparatus 1 to the gas introducing chamber 1C and discharging the gas to the outside.

The fixing member manufacturing apparatus 1 further includes an aging chamber 1B between the heating chamber 1A and the gas introducing chamber 1C. The heating chamber 1A communicates with the gas introducing chamber 1C through the aging chamber 1B through which the roller 50 can be conveyed.

The heating chamber 1A, the aging chamber 1B, and the gas introducing chamber 1C each have a means 4 therein. The roller 50 is conveyed through the interior of each chamber via the conveyance means 4, from the heating chamber 1A to the aging chamber 1B, further into the gas introduction chamber 1C.

### <Heating Chamber>

In the heating chamber 1A, heating of the silicone rubber precursor of the roller 50 is performed. This makes it possible to cure the silicone rubber precursor and to form the rubber member of the fixing member. Further, in the heating chamber 1A, it is also possible to volatilize the low molecular weight compound from the silicone rubber precursor in heating the silicone rubber precursor.

The heating chamber 1A includes a sheath heater 2 for heating the heating chamber 1A and a cooling fan 6 for cooling a control board (not shown) in the heating chamber 1A.

In the example shown in FIG. 3, the exit A_{X} of the heating chamber 1A communicates with the entrance 1B_{N} of the aging chamber 1B. The roller 50 is conveyed into the aging chamber 1B via the conveyance means 4 through the heating chamber 1A.

### <Aging Chamber>

The aging chamber 1B may have tire same configuration as the heating chamber 1A or a gas introduction chamber 1C described later. That is, the aging chamber 1B may have the introduction/discharge means 7 described later, for introducing gas from the outside and discharging the gas to the outside. In this aging chamber 1B, the heated roller 50 having the crosslinked rubber raw material is further heated. If the aging chamber 1B has a means for introducing gas from the outside and discharging gas to the outside, introduction and discharge of the gas are performed, during the heating.

In the example shown in FIG. 3, the exit 1B_{X} of the aging chamber 1B communicates with the entrance 1C_{N} of the gas introduction chamber 1C. The roller 50 is conveyed into the gas introduction chamber 1C via the conveyance means 4 through the aging chamber 1B.

### <Gas Introduction Chamber>

The gas introduction chamber includes the introduction/discharge means 7 for introducing gas from the outside of the fixing member manufacturing apparatus 1 and discharging the gas to the outside. The introduction/discharge means 7 is not particularly limited, as long as gas can be introduced from and discharged to the outside with the introduction/discharge means 7.

Specifically, the example of the gas introduction chamber 1C in FIG. 3 includes a means 7A for introducing gas from the outside and the means 7B for discharging the gas to the outside, thereby introduces/discharges the gas from/to the outside.

In the example of FIG. 3, the means 7B for discharging the gas to the outside includes a discharging fan 70B which discharges the gas to the outside. Specifically, the means 7B for discharging the gas to the outside includes the discharging fan 70B and a discharging duct 72B below the conveyance means 4 in the gas introduction chamber 1C.

The gas in the gas introduction chamber 1C is discharged by the discharging fan 70B. The discarded gas is discharged to the outside of the manufacturing apparatus 1 through the discharging duct 72B.

The means 7A for introducing gas from the outside includes a pressure fan 70A which blows the gas introduced from the outside to the roller 50.

In the example of FIG. 3, specifically, the pressure fan 70A as a means 7A for introducing gas from the outside blows the gas taken from an external gas supply source (not shown) from the upper portion of the gas introduction chamber 1C through the gas supply flow path 72A. As a result, the gas introduced from the outside is introduced into the gas introduction chamber 1C.

In this case, it is preferable that the pressure fan 70A blows the gas introduced from the outside at an angle of 45° or more with respect to the longitudinal direction of the silicone rubber precursor of the roller 50. When the angle is such an angle, the blowing direction is not limited, and for example, as shown in FIG. 3, the gas may be blown from a position above the roller 50.

The external gas supply source is not particularly limited as long as gas can be taken from the outside of the fixing member manufacturing apparatus 1, and specific example thereof includes a gas tank filled with compressed air, dry nitrogen, and the like. In the case of using compressed air, compressed air generated by compressing air at a high pressure by a known compressor may be filled in the gas tank.

The value (V/T) which is the ratio of the total volume V (m³) of the fixing member to the volume T (m³) of the chamber fix introducing the gas from the outside and discharging the gas to the outside is preferably within the range of 0.02 to 0.7, When the value V/T is 0.7 or less, the gas can be sufficiently introduced and discharged. Then, the low molecular weight compound which has been volatilized does not accumulate in the gas, and the low molecular weight compound in the silicone rubber precursor is easily volatilized. When the value V/T is 0.02 or more, turbulent flow due to high speed of introduction and discharge of gas can be suppressed, and uniform heating can be preferably performed. Even if gas at a temperature lower than the temperature inside the chamber is introduced into the chamber, when the value is within the above range, the inside of the chamber is not: cooled by the introduced gas. It is preferable from the viewpoint of reducing thermal efficiency and production cost.

As shown in FIG. 3, the gas introduction chamber 1C may include a punching metal 8 for uniform application of the introduced gas to the roller 50. The pressure fan 70A is provided on the punching metal 8, and a heat resistant filter 9 is provided under the punching metal 8. Such a configuration is preferable because the gas introduced by the pressure fan 70A uniformly hits the roller 50 through the multiple small holes 8a of the punching metal 8. The angle at which the gas is blown may be adjusted by adjusting, the angle at which the small hole 8a is drilled.

### <Other Structures>

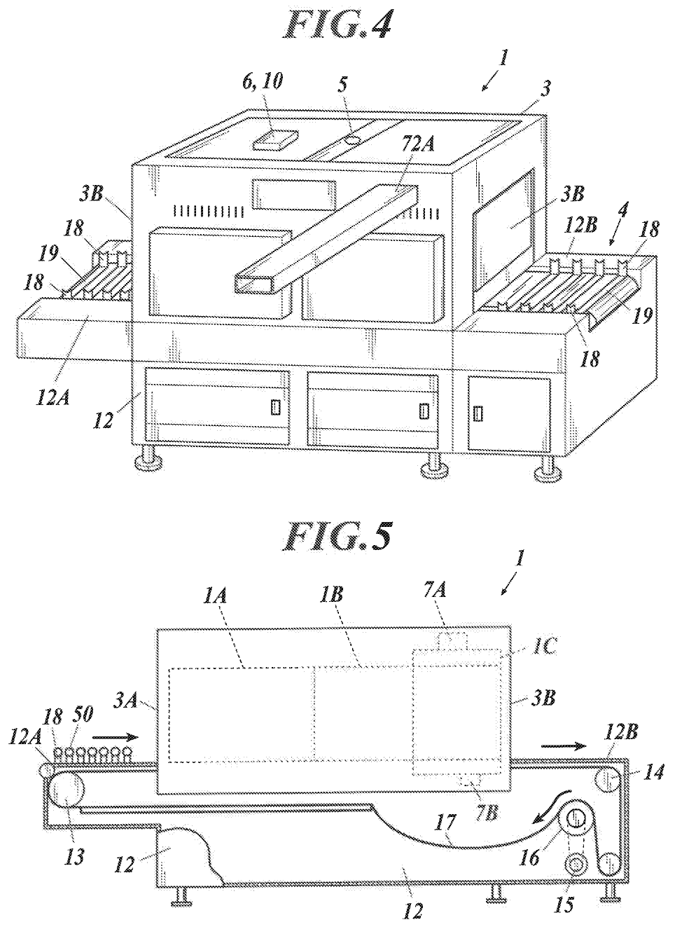

Other structures of the fixing member manufacturing apparatus 1 will be briefly described below with reference to FIG. 5. FIG. 5 is an overall side view of the member manufacturing apparatus 1 shown in FIGS. 3 and 4.

The manufacturing apparatus 1 has an entrance shutter 3A which is an entrance for the roller 50 into the apparatus and an exit shutter 3B which is an exit for the roller 50 to the outside of the apparatus. The conveyance means 4 includes a conveyance frame 12, sprockets 13 and 14, a driving sprocket 16, and a chain 17. The chambers 1A to 1C are installed on the conveyance frame 12. The sprockets 13 and 14 are respectively provided on an entrance base 12A and an exit base 12B of the transfer frame 12 positioned on the entrance side and the exit side. The chain 17 is driven by the driving sprocket 16 and the sprockets 13 and 14. The driving sprocket 16 is provided in the vicinity of the exit base 2B and rotates by a driving motor 15.

Two combinations of the sprockets 13 and 14 and the chain 17 are arranged side by side in the transverse direction of the transfer frame 12.

Multiple plates 19 are arranged at equal intervals between the pair of chains 17. These plates 19 connect the gas inside the chamber: Each of the plates 19 has a pair of roller receivers 18, the paired roller receivers 18 are mounted on respective ends of the plate 19. The roller receivers 18 each have a V-shaped groove and holds the roller 50.

With such a configuration, the conveyance means 4 conveys the roller 50 in parallel to the travelling direction of the chains 17.

The movement of the conveyance means 4 and the like configured as described above will be explained. First, the driving sprocket 16 is rotated by the drive motor 15 to move the chain 17. The moving speed of the chain 17 is set according to a predetermined time required for passing through each chamber. For example, in the heating chamber 1A, the moving speed is set according to the time required for curing the rubber raw material by crosslinking.

The silicone rubber precursor is placed on the roller receivers 18 and driven by the chain so as to enter the heating chamber 1A from the entrance shutter 3A and to be sequentially conveyed to each chamber. The silicone rubber precursor is conveyed to the next chamber after a predetermined time, becomes a fixing member when having passed through the gas introduction chamber 1C, and finally comes out from the exit shutter 3B.

According to such an apparatus and a method, it is possible to easily reduce the amount of the low molecular weight compound without cleaning the fixing member.

### [Electrophotographic Image Forming Apparatus]

Hereinafter, a schematic configuration of a color tandem type image rimming apparatus 100 including the fixing member according to the present invention will be described with reference to FIG. 6. This image forming apparatus is a multi-function machine having functions of a scanner, a copying machine, a printer, and the like, and is called a Multi Function Peripheral or a Multi Function Printer (MFP).

As shown in FIG. 6, the image forming apparatus 100 includes an annular intermediate transfer belt 108 which is wound around two rollers 102 and 106, and moves in a circumferential direction, at a substantially center in a main body casing 101.

Between the two rollers 102 and 106, one (roller 102) is disposed on a left side in the drawing, and the other (roller 106) is disposed on a right side in the drawing. The intermediate transfer belt 108 is supported by these rollers 102 and 106 and rotationally driven along the direction of arrow X.

Below the intermediate transfer belt: 108, sequentially from the left side of the drawing, image forming units 110Y, 110M, 110C, and 110K respectively corresponding to color toners of yellow (Y), magenta (M), cyan (C), and black (K) are arranged side by side.

The individual image forming units 110Y, 110M, 110C, and 110K are configured similarly to each other except that they each treat toner having different colors from each other.

For example, the yellow image forming unit 110Y is configured by integrating a photosensitive drum 190, a charging device 191, an exposure device 192, a developing device 193 which performs development using toner, and a cleaner device 195.

A primary transfer roller 194 is provided at a position facing the photosensitive drum 190 with the intermediate transfer belt 108 interposed therebetween.

At a time of image formation, first, the surface of the photosensitive drum 190 is uniformly charged by the charging device 191. Subsequently, the surface of the photosensitive drum 190 is exposed by the exposure device 192 and a latent image is formed on the surface. Next, the latent image on the surface of the photosensitive dram 190 is developed by the developing device 193, to become a toner image. This toner image is transferred to the intermediate transfer belt 108 by voltage application between the photosensitive drum 190 and the primary transfer roller 194. The residual toner on the surface of the photosensitive drum 190 which has not been transferred is cleaned by the cleaner device 195.

As the intermediate transfer belt 108 moves in the direction of arrow X, toner images of four colors are formed to be superimposed as an output image on the intermediate transfer belt 108 by the image forming units 110Y, 110M, 110C, and 110K.

On the left side of the intermediate transfer belt 108, there is provided a cleaning device 125 which removes residual toner from the surface of the intermediate transfer belt 108, and a toner collection box 126 which collects the toner removed by the cleaning device 125.

On the right side of the intermediate transfer belt 108, there is provided a secondary transfer roller 112 with a conveyance path 124 for the sheet interposed between the secondary transfer roller 112 and the intermediate transfer belt 108. There is provided a conveying roller 120 at a position corresponding to the upstream side of the Secondary transfer roller 112 in the conveyance path 124. There is provided an optical concentration sensor 115 which detects a toner pattern on the intermediate transfer belt 108.

A fixing device 130 which fixes toner on the sheet is provided at an upper tight portion in the main body casing 101.

The fixing device 130 includes a pair of fixing rollers according to the present invention vertically extending with respect to a sheet surface of FIG. 6. One of the fixing rollers is a heating roller 132 and the other is the pressurizing roller 131.

The heating roller 132 is heated by a heater 133 to a predetermined target temperature (e.g., a fixing temperature within a range of 180 to 20092). The pressurizing roller 131 is urged toward the heating roller 132 by a spring (not shown). This causes the pressurizing roller 131 and the heating roller 132 to form a nip portion for the fixation.

As the sheet 90 transferred with the toner image passes through this nip portion, the toner image is fixed on the sheet 90. Temperatures of the pressurizing roller 131 and the heating roller 132 are respectively detected by temperature sensors 135 and 136.

At a bottom of the main body casing 101, sheet feeding cassettes 116A and 116B which accommodate sheets 90 are provided in two stages. FIG. 6 shows a state in which the sheets 90 are accommodated in the sheet feeding cassette 116A alone.

Each of the sheet feeding cassettes 116A and 116B is provided h a sheet feeding roller 118 which feeds sheets, and a sheet feed sensor 117 which detects the fed sheets.

In the main body casing 101, there is provided a control unit 200 including a central processing unit (CPU) which controls an operation of the entire image forming apparatus.

At a time of image formation, under the control of the control unit 200, the sheets 90 are fed one by one from the sheet feeding cassette 116A to the conveyance path 124 by the sheet feeding roller 118. The conveying roller 120 fells the sheets 90 which are fed to the conveyance path 124 to a toner transferring position between the intermediate transfer belt 108 and the secondary transfer roller 112, in timings controlled by a registration sensor

On the other hand, as described above, the toner images of the four colors are formed to be superimposed on the intermediate transfer belt 108 by the respective image forming units 110Y, 110M, 110C, and 110K, and the toner images of the four colors on the intermediate transfer belt 108 are transferred by the secondary transfer roller 112 onto each of the sheets 90 fed to the toner transferring position.

The sheets 90 transferred with the toner image are conveyed through the nip portion formed by the pressurizing roller 131 and the heating roller 132 of the fixing device 130, and subjected to heating and pressurization. This fixes the toner image on the sheet 90.

Finally, the sheets 90 with fixed the toner image are discharged to a sheet discharging tray 122 provided on an upper surface of the main body casing 101, by a discharge roller 121 through a discharge path 127.

In the image forming apparatus 100, there is provided a switchback conveyance path 128 to feed the sheets 90 to the toner transferring position again in the case of duplex printing.

As described above, the pressurizing roller 131 constitutes one of the fixing rollers, which is a silicone rubber roller in this embodiment.

It is noted that the embodiments applicable with the present invention are not limited to the above-mentioned embodiments, and can be appropriately changed without departing from the gist of the present invention.

For example, in the manufacturing method and the manufacturing apparatus for the fixing member according to the present invention, the heating chamber may also serve as the gas introducing chamber as described above.

That is, while curing the silicone robber on the surface layer of the silicone rubber precursor, the gas introducing chamber may reduce the amount of a low molecular weight compound.

Further, when the heating chamber also serves as the gas introducing chamber (that is, when there is provided a unit which introduces/discharges gas from/to the outside), while the silicone rubber precursor is heated in the heating chamber, the gas may be introduced from and discharged to the outside, in this heating chamber. This allows the process to be performed in a short time.

In this case, as the unit which introduces/discharges the gas from/to the outside, the beating chamber may have the introduction/discharge means 7 which introduces/discharges the gas from/to the outside as in the gas introducing chamber 1C shown in FIG. 3.

Further, the heating chamber may also serve as the aging chamber, and furthermore, the heating chamber may also serve as the aging chamber and the gas introducing chamber. In such a case, the fixing member manufacturing apparatus according to the present invention may have one heating chamber 1A alone having a similar configuration to the gas introducing chamber 1C shown in FIG. 3.

It is also possible to rotate the silicone rubber precursor in each chamber, so that the gas uniformly blows thereon.

In the above description, the fixing roller has been described as an example of the fixing member, but the fixing belt can also be manufactured and used in the same manner. The fixing belt: according to the present specification refers to a fixing belt of a silicone rubber used for fixing toner on a sheet in an electrophotographic image forming apparatus. Specifically, for example, it refers to a known fixing belt used in the fixing device described in Japanese Unexamined Patent Application Publication Nos. 2017-194550, 2017-173445, and 2017-97187.

### EXAMPLES

Hereinafter, the present invention will be specifically described with reference to examples of a fixing roller as the fixing member, but the present invention is not limited thereto.

### <Preparation of Fixing Roller>

To 100 parts by mass of a two-component room temperature curing type silicone rubber (trade name: KE-1602, manufactured by Shin-Etsu Chemical Co., Ltd.) was added 10 parts by mass of a curing agent (trade name: CAT 1602, manufactured by Shin-Etsu Chemical Co., Ltd.), and thoroughly mixed with an agitator to obtain a silicone rubber mixture C.

To the silicone rubber mixture C was added 15 parts by mass of expanded Expancel 461, and mixed with an agitator for 30 minutes to obtain a silicone rubber mixture D. Expancel 461 is a microballoon manufactured by Akzo Nobel N.V, having an outer shell that is a copolymer of vinylidene chloride and acrylonitrile, and is melted at 110 C. Unexpanded spherical diameter was 10 to 16 μm, and in this case, heating was performed at 100° C. for 10 minutes to obtain an expanded microballoon with a spherical diameter of 40 to 60 μm.

Apart from the preparation of the silicone rubber mixtures C and D, a core metal made of aluminum (length of 370 mm, diameter of 22 mm) was applied with an adhesive, covered with a paper tube having a diameter larger than the core metal by 15 mm with the core metal being in a center, and provided with a bottom lid.

Thereafter, the silicone rubber mixture C (not containing microballoons) was poured between the paper tube and the cure metal, and the mixture was left to stand for twenty four hours at mom temperature to complete curing. Thereafter, the paper tube was removed to form a solid rubber layer.

Thereafter, to this solid rubber layer, the silicone rubber mixture D (including microballoons) was applied in a thickness of 100 μm, and left, to stand for twenty-four hours. Then, the surface was polished with a polisher, and there was formed a sponge rubber layer embedded with numerous microballoons of about 40 to 60 μm.

By these processing, a silicone rubber precursor was obtained (a roller for a copying machine, a surface length of rubber layer of 340 mm, see FIG. 2), having a two-layer structure of an outer layer of the sponge rubber and an inner layer of the solid rubber.

The roller having a silicone rubber precursor formed on the core metal prepared as above was conveyed to the gas introduction chamber and heated at 179° C. for 1 hour in the gas introduction chamber. In the heating, compressed air was introduced into the gas introduction chamber, and the gas in the chamber was also discharged. Normal atmosphere was compressed at high pressure by a compressor so as to have a water content of 5 mass % and was used as the compressed air. The compressed air introduced from the outside was blown onto the silicone rubber precursor at an angle of 80″ with respect to the longitudinal direction of the silicone rubber precursor. The introduction and discharge speeds of the gas were each set to 9×(m³/min). Here, V represents the volume of the roller on which the silicone rubber precursor is formed, that is, the volume of the fixing roller.

After the processing of reducing a low molecular weight compound as described above, the fixing member was taken out from the chamber and a fixing roller 1 was obtained.

After the above curing (vulcanization) processing, the diameter (outer diameter) of the fixing roller 1 was 30 mm and the thickness of the silicone rubber was 4 mm.

### <Preparation of Fixing Rollers 2 to 9>

Fixing rollers 2 to 9 were prepared in the same manner as in the preparation of fixing roller 1, except that the heating temperature in the gas introduction chamber was changed to the temperatures described in Table I and that the heating time was also changed so that the cumulative amount of the low molecular component and the cumulative amount of the high molecular weight component according to the head space gas chromatography measurement were the cumulative amounts described in Table I.

In the preparation of the fixing rollers 6 and 8, heating was not performed. Further, in the preparation of the fixing roller 8, vacuum drying processing (conditions: 30° C., 50 hPa, 2 hours) was performed. The vacuum drying processing was performed using a vacuum oven (trade name: VAC-101P, manufactured by Espec Corp.).

### <Measurement of Rubber Hardness on Shaft>

The surface hardness of each fixing roller was measured in accordance with SIS-S-60:50. Specifically, it was measured with an ASKER-C type rubber hardness tester (manufactured by Kobunshi Keiki Co., Ltd.) under a load of 600 g. In order to observe the rubber hardness on the shaft, the measurement was performed using a positioning member so that the pressing indenter could be positioned directly above the portion perpendicular to the circumferential direction of the roller. A roller having an outer diameter of 30 mm including a core material with a diameter of 22 mm and a rubber having a thickness of 4 mm was prepared as a fixing roller and the rubber hardness was measured. In the measurement of the rubber hardness, the hardness was measured in a state where rubber was placed on the surface of the core material.

### <Head Space Gas Chromatography Measurement>

From the silicone rubber of each fixing roller. The head space gas chromatography measurement using the measurement device under column conditions and temperature rising conditions as follows. The cumulative amount of the low molecular weight component from 10 minutes to 32 minutes after starting retention and the cumulative amount of the high molecular weight component from 32 minutes to 37 minutes after starting retention were calculated.

Measurement device: (GC-2010 (manufactured by Shimadzu Corp.))

Column conditions: DB -5 MS (manufactured by Agilent Technologies, Inc.), column flow rate 3 mL/min, carrier gas (He) 83 kPa

Temperature rising conditions: The time of injecting the sample was set to 0 minutes from the start of retention. After the injection, the oven temperature was kept at 40° C. for 5 minutes, raised to 140° C. at a rising rate of 5° C./min, raised to 320° C. at a rising rate of 20° C./min, and finally kept at 320° C. for 7 minutes,

The silicone rubber composition to be measured was dissolved in 1 g of hexane and used as the above sample.

### <Evaluation of Number of Volatile Particles>

Printing was performed in a closed space in which was hermetically sealed a copying machine equipped with the fixing member produced as described above, and the atmosphere was collected and analyzed. Specifically, each fixing member was incorporated in a fixing device of bizhub C308 (manufactured by Konica Minolta Inc.). Then, this modified machine was placed in a chamber made of SUS having a volume of 5 m³, and ventilation was performed at an air flow rate of 15 m³/h. After ventilation for about 1 hour, printing was performed for 10 minutes, and volatile substances generated from an inside of the machine were sampled by a Tenax tube at the rate of 10 mL/min. The sampling was further performed for about 20 minutes, even after the printing was stopped. The atmosphere was measured with FMPS and the cumulative number of the particles was counted. When the count peak value was 3000 cps (count(s) per second) or less, the fixing roller was determined to be acceptable.

### <Evaluation of Durability>

With a copying machine “bizhub PRO (registered trademark) C6501” (manufactured by Konica Minolta Inc.) equipped with the fixing roller used in the evaluation of the number of volatile particles produced as described above, printing of 100,000 sheets and 200,000 sheets was performed in a normal temperature and normal humidity environment (23° C., 50% RH), and thereafter the fixing property was evaluated. The evaluation of fixing property was performed on the basis of a folding rank temperature described later.

In the present invention, a fixing roller having the folding rank temperature of 160° C. or less was determined to be acceptable.

The folding rank temperature was measured as follows.

A solid black image was output: (transferred) onto evaluation sheets (A3 sheets of “CF80 sheet (80 g/m²)”), using a black developer. Fixation processing was performed on the unfixed solid black image, with the fixing temperature increasing in 5° C. increments (from 100° C. to 180° C.). The printed sheet obtained at each fixing temperature was folded at the center of the fixed solid black image. A weight of 500 g was put on the fold, reciprocated on the fold five times, and removed. Subsequently, the folded sheet was opened. The width of a damaged portion at the fold in the image was measured with a vernier caliper. The folding rank temperature was determined as the lowest temperature among the fixing temperature(s) (between 100 and 180° C.) used for fixing images with the damaged width exceeding 1 mm.

TABLE I

| | | HEAD SPACE GAS | | | | | | |
|---|---|---|---|---|---|---|---|---|
| | | CHROMATOGRAPHY | | | | | | |
| | | MEASUREMENT | | | | | | |
| | | CUMULATIVE | CUMULATIVE | | EVALUATION | | | |
| | | AMOUNT OF | AMOUNT OF | | | DURABILITY | | |
| | | LOW | HIGH | | | FOLDING | FOLDING | |
| | | MOLECULAR | MOLECULAR | | | RANK | RANK | |
| | | WEIGHT | WEIGHT | | | TEMPER- | TEMPER- | |
| | | COMPONENT | COMPONENT | | | ATURE | ATURE | |
| | | FROM 10 | FROM 32 | | NUMBER | AFTER | AFTER | |
| | | MINUTES TO 32 | MINUTES TO 37 | RUBBER | OF | PRINTING | PRINTING | |
| FIXING | HEATING | MINUTES AFTER | MINUTES AFTER | HARDNESS | VOLATILE | 100,000 | 200,000 | |
| ROLLER | TEMPERATURE | STARTING | STARTING | ON SHAFT | PARTICLES | SHEETS | SHEETS | |
| NO. | [° C.] | RETENTION | RETENTION | [°] | [CPS] | [° C.] | [° C.] | REMARKS |
| 1 | 179 | 1.34 | 2.51 | 45 | 2685 | 148 | 148 | PRESENT |
| | | | | | | | | INVENTION |
| 2 | 188 | 0.75 | 2.29 | 50 | 1551 | 149 | 151 | PRESENT |
| | | | | | | | | INVENTION |
| 3 | 188 | 0.74 | 2.21 | 28 | 1653 | 151 | 153 | PRESENT |
| | | | | | | | | INVENTION |
| 4 | 188 | 0.75 | 2.45 | 61 | 1602 | 152 | 152 | PRESENT |
| | | | | | | | | INVENTION |
| 5 | 175 | 1.40 | 2.30 | 51 | 2960 | 148 | 148 | PRESENT |
| | | | | | | | | INVENTION |
| 6 | NO HEATING | 1.93 | 2.35 | 51 | 350000 | 152 | 153 | COMPARATIVE |
| | | | | | | | | EXAMPLE |
| 7 | 230 | 0.16 | 0.70 | 25 | 1550 | 165 | 168 | COMPARATIVE |
| | | | | | | | | EXAMPLE |
| 8 | NO HEATING | 1.57 | 2.34 | 45 | 100000 | 153 | 154 | COMPARATIVE |
| | (#1) | | | | | | | EXAMPLE |
| 9 | 220 | 1.10 | 2.05 | 25 | 1588 | 162 | 165 | COMPARATIVE |
| | | | | | | | | EXAMPLE |

(#1: vacuum drying processing was performed (30° C., 50 hPa, 2 hours))

### (Summary)

From are results in Table it was found that the fixing roller having the silicone rubber member formed from the silicone rubber composition of the present invention has a small number of volatile particles. That is, it was found that contamination of peripheral members due to volatilization of low molecular components in the silicone rubber can be suppressed. Further, it was found that the fixing roller of the present: invention was excellent in durability.

On the other hand, the fixing rollers of the comparative examples were inferior at least one of the evaluation items.

In the above-described of method of manufacturing a fixing member, the fixing roller is described as an example of the fixing increment; however, the fixing belt can be similarly manufactured.

Although embodiments of the present invention have been described and illustrated in detail, it is clearly understood that the same is by way of illustration and example only and not limitation, the scope of the present invention should be interpreted by terms of the appended claims.

Japanese Patent Application No. 2018-021600 filed on Feb. 9, 2018, including description, claims, drawings, and abstract of the entire disclosure is incorporated herein by reference in its entirety.

What is claimed is:

1. A silicone rubber composition forming a rubber member on a surface of a fixing member which is used in an electrophotographic image forming apparatus, comprising:
1.5 or less of a low molecular weight component by a cumulative amount measured from 10 minutes to 32 minutes after starting retention in a head space gas chromatography measurement under a predetermined condition; and
2.2 or more of a high molecular weight component by a cumulative amount measured from 32 minutes to 37 minutes after starting retention in a head space gas chromatography measurement under the predetermined condition.

2. The silicone rubber composition according to claim 1,
wherein the cumulative amount of the low molecular weight component is 1.3 or less and the cumulative amount of the high molecular weight component is 2.28 or more.

3. A fixing member which is used in an electrophotographic image forming apparatus, comprising a rubber member on a surface of the fixing member,
wherein the rubber member is formed from the silicone rubber composition according to claim 1.

4. A fixing roller comprising the fixing member according to claim 3,
wherein the fixing member comprises the rubber member as an outer layer which coats a core material, and
wherein a rubber hardness of the rubber member on a shaft is within a range of 30° to 60°.

5. A manufacturing method of a fixing member for manufacturing the fixing member according to claim 3, comprising a step of introducing gas into a heating device from outside in heating, by the heating device, a fixing member which has a surface having a silicone rubber member and which is placed in the heating device,
wherein a maximum temperature in the heating by the heating device is 190° C. or less.

6. The manufacturing method of a fixing member according to claim 5, wherein a maximum temperature in the heating by the heating device is 180° C. or less.
